(19) United States
(12) Patent Application Publication
(10) Pub. No.: US 2023/0410644 A1
(43) Pub. Date: Dec. 21, 2023

(54) CONGESTION JUDGMENT METHOD, CONGESTION JUDGMENT DEVICE, AND CONGESTION JUDGMENT PROGRAM

(71) Applicant: NIPPON TELEGRAPH AND TELEPHONE CORPORATION, Tokyo (JP)

(72) Inventors: Aki HAYASHI, Tokyo (JP); Yuki YOKOHATA, Tokyo (JP); Takahiro HATA, Tokyo (JP); Kohei MORI, Tokyo (JP); Kazuaki OBANA, Tokyo (JP)

(73) Assignee: NIPPON TELEGRAPH AND TELEPHONE CORPORATION, Tokyo (JP)

(21) Appl. No.: 18/036,865

(22) PCT Filed: Nov. 17, 2020
(86) PCT No.: PCT/JP2020/042760

§ 371 Date: May 12, 2023

(51) Int. Cl. G08G 1/01

(52) U.S. Cl. CPC G08G 1/0133; G08G 1/0141; G08G 1/0129

(57) ABSTRACT

A traffic congestion determination device includes an acquisition unit configured to acquire a total number of automobiles for each mesh obtained by virtually dividing a determination target region of traffic congestion and for each unit time, and a determination unit configured to determine whether occurrence of traffic congestion is sudden for each of the meshes based on the acquired total number of automobiles for each of the meshes and unit time.

### TECHNICAL FIELD

The disclosed technology relates to traffic congestion determination method, traffic congestion determination device, and traffic congestion determination program.

### BACKGROUND ART

Attempts to estimate traffic congestion using images have been made for a long time. For example, there is a technique of estimating a behavior of a vehicle using an image captured by a fixed camera (for example, see Non Patent Literature 1).

There is a possibility of being able to estimate the location where traffic congestion occurs using the behavior of a vehicle. However, in order to target a wide range, it is necessary to install many cameras, and it is also necessary to transmit an image or encoded data from the camera to an arithmetic device for processing an image.

In addition, it is difficult to appropriately notify an appropriate user of an estimation result even if it is possible to estimate the occurrence of traffic congestion or the cause of traffic congestion by simply processing an image. The appropriate user mentioned here is, for example, a user whose living area includes an area where traffic congestion occurs chronically, and the appropriate notification is notification of the sudden occurrence of traffic congestion. That is, it is not necessary to notify a user whose living area includes an area where traffic congestion occurs chronically of the chronic occurrence of traffic congestion, and it is preferable to notify only of the sudden occurrence of traffic congestion.

### CITATION LIST

### Non Patent Literature

Non Patent Literature 1: “Detailed analysis of traffic congestion occurrence mechanism using image analysis method on urban expressway”, http://www.ce.it-chiba.ac.jp/atrans/ronbun/akahane/2007/2007%20tosi%20kousokudouro.pdf

### SUMMARY OF INVENTION

### Technical Problem

The disclosed technology has been made in view of the above points, and an object thereof is to provide traffic congestion determination method, traffic congestion determination device, and traffic congestion determination program capable of determining whether traffic congestion has occurred suddenly.

### Solution to Problem

In order to achieve the above object, traffic congestion determination method according to an aspect of the present disclosure is traffic congestion determination method in traffic congestion determination device including an acquisition unit and a determination unit, in which the acquisition unit acquires a total number of automobiles for each mesh obtained by virtually dividing a determination target region of traffic congestion and for each unit time, and the determination unit determines whether occurrence of traffic congestion is sudden for each of the meshes based on the acquired total number of automobiles for each of the meshes and unit time.

Furthermore, in order to achieve the above object, traffic congestion determination device according to an aspect of the present disclosure includes an acquisition unit configured to acquire a total number of automobiles for each mesh obtained by virtually dividing a determination target region of traffic congestion and for each unit time, and a determination unit configured to determine whether occurrence of traffic congestion is sudden for each of the meshes based on the acquired total number of automobiles for each of the meshes and unit time.

Furthermore, in order to achieve the above object, traffic congestion determination program according to an aspect of the present disclosure causes a computer to execute acquiring a total number of automobiles for each mesh obtained by virtually dividing a determination target region of traffic congestion and for each unit time, and determining whether occurrence of traffic congestion is sudden for each of the meshes based on the acquired total number of automobiles for each of the meshes and unit time.

### Advantageous Effects of Invention

According to the disclosed technology, it is possible to determine whether the traffic congestion has occurred suddenly.

### BRIEF DESCRIPTION OF DRAWINGS

FIG. 1 is a diagram illustrating an example of a visit probability for each place.

FIG. 2 is a block diagram illustrating an example of a hardware configuration of traffic congestion determination device according to a first embodiment.

FIG. 3 is a block diagram illustrating an example of a functional configuration of the traffic congestion determination device according to the first embodiment.

FIG. 4 is a diagram illustrating an example of the total number of automobiles for each place.

FIG. 5 is a flowchart of traffic congestion determination processing according to the first embodiment.

FIG. 6 is a block diagram illustrating an example of functional configurations of traffic congestion determination device according to a second embodiment.

FIG. 7 is a flowchart of traffic congestion determination processing according to the second embodiment.

FIG. 8 is a graph illustrating deviation of a time zone of GPS log data.

FIG. 9 is a graph illustrating deviation of a day of the week of the GPS log data.

FIG. 10 is a graph of the number of logs representing the number of pieces of log data for each mesh.

FIG. 11 is a diagram illustrating a result of applying RBM to GPS log data of a taxi.

FIG. 12 is a diagram illustrating a place where the automobile passed chronically.

FIG. 13 is a graph illustrating deviation of a day of the week and a time zone of a place where a habit degree is high.

FIG. 14 is a diagram illustrating a distribution of an aggregation sudden index calculated by SICM.

FIG. 15 is a diagram plotting transitions of the aggregation sudden index and the number of logs at three places where the aggregation sudden index was the highest.

FIG. 16 is a diagram in which the aggregation sudden index is plotted on a map by dividing the calculated aggregation sudden index into 8 levels for 160 places where the aggregation sudden index was equal to or higher than 1.0.

FIG. 17 is a diagram illustrating a reduction rate of an adoption rate and a calculation cost for the mesh in which the traffic congestion has actually occurred in a case where the aggregation sudden index is calculated for each mesh using the dynamic aggregation statistical information.

FIG. 18 is a diagram illustrating a reduction rate of an adoption rate and a calculation cost for the mesh in which the traffic congestion has actually occurred in a case where the aggregation sudden index is calculated for each mesh using the static aggregation statistical information.

FIG. 19 is a diagram illustrating a result of calculating traffic congestion habit degree using RBM for a mesh whose aggregation sudden index calculated using GPS log data for the last 33 days is equal to or higher than a threshold value.

FIG. 20 is a diagram illustrating a result of calculating, for all meshes, a correlation coefficient between a weighted habit degree calculated by SRBM every time when traffic congestion is detected for 15 traffic congestions detected in Odaiba and a traffic congestion habit degree calculated by RBM after all 15 traffic congestions are detected.

FIG. 21 is a diagram illustrating a change in weight when the weighted traffic congestion habit degree is calculated.

### DESCRIPTION OF EMBODIMENTS

Hereinafter, an example of an embodiment of the disclosed technology will be described with reference to the drawings. In the drawings, the same or equivalent components and portions will be denoted by the same reference signs. Further, dimensional ratios in the drawings are exaggerated for convenience of description and thus may be different from actual ratios.

### <Outline of Traffic Congestion Detection>

Some traffic congestion that occurs on a roadway occurs only in a specific lane for reasons such as an entrance to a facility or waiting for a traffic light. When such traffic congestion occurs, there are cases where the head position cannot be seen from the tail position of the traffic congestion, and it is not clear whether the host vehicle should line up in the traffic congestion or whether the host vehicle may pass the traffic congestion in another lane. When such cases increase, there is a problem that the time required to reach a destination increases or unnecessary congestion occurs.

In order to solve such a problem, it is conceivable to estimate a traffic congestion occurrence position (head and tail) of an automobile in a specific lane on a road using captured image data of a captured image (for example, a moving image) captured by an in-vehicle camera and position information from the Global Positioning System (GPS) and notify a driver of the information, but there are the following problems.
(1) Since the captured image data is used, the calculation cost for estimating the traffic congestion occurrence position increases. In addition, a communication cost for uploading captured image data from a general vehicle to the server also increases.
(2) In a case where a user who drives an automobile is notified of occurrence of traffic congestion, the notification is repeatedly made to a user whose living area includes an area where traffic congestion occurs chronically. Therefore, there is a possibility of the number of unnecessary notifications increasing and the satisfaction degree of the user decreasing.

For the problem of (1), it is conceivable to limit the area where the traffic congestion occurrence position is estimated using the captured image data to an area where sudden traffic congestion occurs. As a result, it is possible to suppress the calculation cost by omitting the processing of estimating the traffic congestion occurrence position for an area where traffic congestion repeatedly occurs due to the same cause, such as an entrance to a facility.

With respect to the above problem (2), it is considered that the satisfaction degree of the user is improved by notifying only the occurrence of the sudden traffic congestion without notifying the occurrence of the chronic traffic congestion to the user whose living area includes the area where the traffic congestion occurs.

The traffic congestion for each lane includes traffic congestion for each lane that occurs periodically and traffic congestion for each lane that occurs suddenly. The traffic congestion that occurs periodically is considered to have time dependency such as repeated occurrence in a specific day of the week or the time zone. The time axis on which the occurring traffic congestion most strongly depends varies depending on the place where the traffic congestion occurs. For example, traffic congestion may often occur on a specific day of the week but not necessarily be biased toward a specific time zone, traffic congestion may often occur in a specific time zone but occur every day without deviation in the day of the week, or traffic congestion may always occur without dependency on the day of the week or the time zone. For example, the traffic congestion on a right/left turning lane of a highway is likely to occur during rush hours in the morning and evening, waiting to enter a commercial facility is likely to occur on Saturday, Sunday, and holidays, and traffic congestion in a merging lane of a highway and a general road is likely to occur at all times due to a signal cycle or the like, and it can be said that these are predictable from the periodicity. On the other hand, the traffic congestion for each lane that occurs suddenly includes traffic congestion in which an obstacle such as an accident or an injured person blocks a lane, traffic congestion caused by an event such as a sale at a commercial facility or a new opening, and traffic congestion caused by a change in daily habits such as a special demand for a drive-through due to a coronavirus issue. Since these are unpredictable and have a high possibility of causing an accident, it is necessary to collect captured image data such as videos from a plurality of automobiles and analyze the captured image data, and it is also necessary to notify a user whose living area includes an area where the traffic congestion has occurred of the occurrence of the traffic congestion. Therefore, it is necessary to comprehensively consider various time axes such as a day of the week and a time zone, and then index whether the occurred traffic congestion is sudden or chronic. At this time, the index is not obtained for each time axis, but needs to be unified so that it can be determined which captured image data of traffic congestion should be collected. In addition, since it is necessary to notify of the traffic congestion information in as close to real time as possible, it is also necessary to quickly determine the chronic/sudden nature of the traffic congestion, and it is difficult to apply abnormal value detection using a complicated model such as Auto Encorder.

As a method of indexing whether an occurring event is sudden or chronic in a unified manner at a high speed in consideration of a plurality of time axes such as a day of the week and a time zone at the same time, there are techniques disclosed in Patent Literature 1 and Patent Literature 2 below.
(Patent Literature 1) JP 2015-153088 A
(Patent Literature 2) JP 2016-91040 A

In the technology disclosed in Patent Literature 1, a “habit degree” that indicates how sudden or chronic a visit to a certain visit place is by comprehensively considering a plurality of time axes is calculated using position information of a user.

When the technique disclosed in Patent Literature 1 is applied to cope with the problems (1) and (2) in traffic congestion detection, there are the following problems.

First, a problem related to the above (1) will be described.

Since the technique disclosed in Patent Literature 1 is originally intended for human actions, an index for an event in which a visit itself has occurred is calculated as the habit degree, instead of an index incidental to a visit. Specifically, a visit probability for each place is calculated only for a specific user, and the degree of suddenness is calculated as the habit degree by comparing a visit probability of a visit place for which the habit degree is to be calculated with a visit probability of another place.

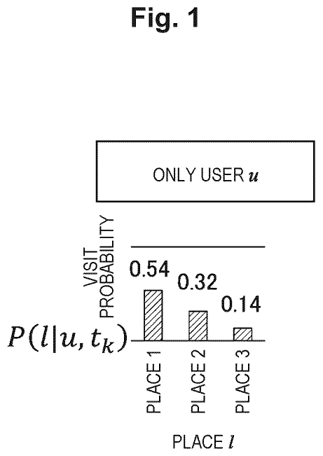

FIG. 1 illustrates an example of a visit probability for each place calculated by the technology disclosed in Patent Literature 1. In addition, a formula for calculating the habit degree R(l, u, t) disclosed in Patent Literature 1 is expressed by the following expression.

$$ℛ ( l , u , t ) = {\sum }_{k} ω ( u , {t}_{k} ) \frac{P ( l \vert u , {t}_{k} ) - μ ( u , {t}_{k} )}{σ ( u , {t}_{k} )} \qquad ( 1 )$$

Here, k is a parameter indicating the type of time axis of the day of the week (k=1), the time zone (k=2), the day of the week and the time zone (k=3), and no time consideration (k=4).

tₖ represents a time zone of the calculation target of the habit degree. For example, in a case where k=2 and the time zone of the calculation target of the habit degree is between 13:00 and 14:00, t₂=13 is expressed.

P(l|u, tₖ) is a visit probability of a user u to a place l in the time zone tₖ. The place l is a mesh obtained by virtually dividing traffic congestion determination target region in the present embodiment, and will be hereinafter referred to as a mesh l. The mesh can be, for example, a square region of 100 m in length and width, but the size and shape of the mesh are not limited thereto.

Note that the following expression holds for P(l|u, tₖ)

$${\sum }_{l} P ( l \vert u , {t}_{k} ) = 1$$

ω(u, tₖ) is a weight of the time zone tₖ for the user U.

μ(u, tₖ) is an average of the visit probabilities for all the meshes of the user u on a time axis k and the time zone tₖ.

σ(u, tₖ) is a standard deviation of the visit probabilities for all the meshes of the user u on the time axis k and the time zone tₖ.

On the other hand, in the case of traffic congestion detection, it is necessary to index whether the total number of automobiles per unit time whose presence is detected in a specific mesh is sudden, instead of an event in which a certain automobile visits a specific mesh.

In Patent Literature 1, the habit degree is calculated as an index indicating how sudden the “visit probability” for the visit place is compared with other places. However, in the traffic congestion detection, it is necessary to calculate an index indicating how suddenly the total number of automobiles on the time axis for which the index is to be calculated will increases as compared with the previous “total number of automobiles” of the same mesh. Therefore, the technology disclosed in Patent Literature 1 cannot be applied as it is.

In Patent Literature 1, the habit degree calculated on each time axis is weighted by an appropriate specific gravity to calculate the overall habit degree. The weight ω(u, tₖ) is calculated by the following equation in consideration of how many visits the user u records including other places in the same time zone.

$$ω ( u , {t}_{k} ) = \frac{N ( u , {t}_{k} )}{{max}_{{t}_{k}^{′}} N ( u , {t}_{k}^{′} )} \qquad ( 2 )$$

Here, N(u, tₖ) is a total value of the number of visits to all places by the user u in the time zone tₖ.

$${max}_{{t}_{k}^{′}} N ( u , {t}_{k}^{′} )$$

is a total value of the number of visits to all places in a time zone tₖ′ in which the user u has recorded the most visits in all time zones on the time axis k.

In the traffic congestion detection, since it is desired to calculate an index indicating how much the total number of automobiles suddenly increases regardless of the user u, Expression (2) above cannot be used as it is. Hereinafter, an index indicating the degree of sudden increase of the total number of automobiles in the traffic congestion detection is referred to as an aggregation sudden index or a Suddenness Index Calculation Method (SICM). In addition, in the case of calculating the aggregation sudden index for a wide range of places, while it is necessary to suppress the calculation cost of the aggregation sudden index itself, it is necessary to avoid calculating the number of visits to all places as in Expression (2) above since the aggregation sudden index cannot be calculated independently for each mesh.

In the technique disclosed in Patent Literature 2, when there is a certain event, the habit degree on a plurality of time axes is calculated based on the number of occurrences and the occurrence probability of the event so far. Also in this case, since the probability of the occurrence of the event itself is calculated for each user instead of the habituation based on the magnitude of the number such as the “total number of automobiles”, it cannot be used for the purpose of calculating the degree of sudden occurrence of the counted value such as the aggregation sudden index.

Next, a problem related to the above (2) will be described.

In a case where it is determined whether the traffic congestion has occurred suddenly or chronic in order to determine the presence or absence of the notification of the occurrence of the traffic congestion to the user, it is sufficient to calculate the habit degree for the event itself that the traffic congestion has occurred. Therefore, application of the technology disclosed in Patent Literature 1 is considered.

In the above (1), it is necessary to calculate the aggregation sudden index from the total number of automobiles before detecting whether traffic congestion has occurred. However, this is because, in (2) above, it is only necessary to determine whether the traffic congestion is sudden or chronic after the traffic congestion is detected by a known method.

However, actually, the traffic congestion detection for each lane has a high calculation cost and the like, and in an initial stage where the number of samples of the traffic congestion detection result is small, the accuracy of the calculated habit degree becomes a problem.

As described above, in the first embodiment, in order to solve the above problem (1), the aggregation sudden index is calculated for each mesh based on the total number of automobiles aggregated in each mesh. As a result, it is possible to simplify the processing of traffic congestion detection by acquiring captured image data captured by an automobile present in an area where traffic congestion occurs and analyzing the captured image data, which is the subsequent processing.

In addition, in the second embodiment, in order to solve the above problem (2), whether the traffic congestion has occurred suddenly or chronic is calculated as the habit degree. However, in an initial stage where the number of log data acquired for traffic congestion detection is small, the habit degree is calculated in consideration of past GPS log data of a taxi or the like, past traffic congestion history of a road and a section, and the like although there is no data for each lane. Then, the occurrence of chronic traffic congestion is not notified to users whose living area includes an area where traffic congestion has occurred, but is notified only to users whose living area does not include the area where traffic congestion has occurred. In this manner, the notification target of the occurrence of traffic congestion may be switched depending on whether the occurred traffic congestion is sudden or chronic.

### First Embodiment

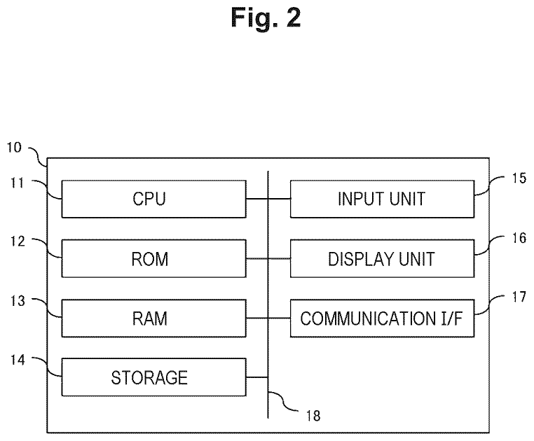

FIG. 2 is a block diagram illustrating an example of a hardware configuration of traffic congestion determination device 10 according to the present embodiment.

As illustrated in FIG. 2, the traffic congestion determination device 10 includes a central processing unit (CPU) 11, a read only memory (ROM) 12, a random access memory (RAM) 13, a storage 14, an input unit 15, a display unit 16, and a communication interface (I/F) 17. The components are communicably connected to each other via a bus 18.

The CPU 11 is a central processing unit, and executes various programs and controls each unit. That is, the CPU 11 reads the programs from the ROM 12 or the storage 14 and executes the programs by using the RAM 13 as a work area. The CPU 11 controls each component described above and performs various types of operation processing according to the programs stored in the ROM 12 or the storage 14. In the present embodiment, the ROM 12 or the storage 14 stores a traffic congestion determination program for determining whether the traffic congestion is sudden.

The ROM 12 stores various programs and various types of data. The RAM 13 temporarily stores the programs or data as a work area. The storage 14 includes a hard disk drive (HDD) or a solid state drive (SSD) and stores various programs including an operating system and various types of data.

The input unit 15 includes a pointing device such as a mouse and a keyboard and is used to perform various inputs to the allocation search device.

The display unit 16 is, for example, a liquid crystal display and displays various types of information. The display unit 16 may function as the input unit 15 by adopting a touchscreen system.

The communication interface 17 is an interface through which the allocation search device communicates with another external device. The communication is performed in conformity to, for example, a wired communication standard such as Ethernet (registered trademark) or fiber distributed data interface (FDDI) or a wireless communication standard such as 4G, 5G, or Wi-Fi (registered trademark).

For example, a general-purpose computer device such as a server computer or personal computer (PC) is applied to the traffic congestion determination device 10 according to this embodiment.

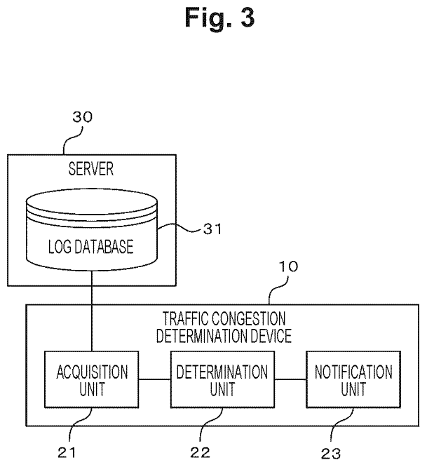

Next, functional configurations of the traffic congestion determination device 10 will be described with reference to FIG. 3.

FIG. 3 is a block diagram illustrating an example of functional configurations of the traffic congestion determination device 10 according to the present embodiment.

As illustrated in FIG. 3, the traffic congestion determination device 10 includes an acquisition unit 21, a determination unit 22, and a notification unit 23 as functional configurations. Each functional configuration is achieved by a CPU 11 reading a traffic congestion determination program stored in a ROM 12 or a storage 14, developing the traffic congestion determination program in a RAM 13, and executing the traffic congestion determination program.

The acquisition unit 21 acquires the total number of automobiles for each mesh obtained by virtually dividing traffic congestion determination target region and for each unit time. The total number of automobiles is acquired from a log database 31 included in a server 30.

The log database 31 is a database representing a correspondence relationship among a mesh ID which is an identification code representing a mesh, a date and time, a day of the week, and a total number of automobiles aggregated in the mesh.

The server 30 collects own vehicle position information (latitude and longitude) transmitted from a GPS device such as a connected car traveling in traffic congestion determination target region and an automobile having a connection function to the Internet, and sequentially updates the log database 31. Note that the traffic congestion determination device 10 may have the function of the server 30. In addition, the server 30 may collect the number of automobiles for each mesh by acquiring satellite images and analyzing the images, and sequentially update the log database 31.

The server 30 converts the latitude and longitude indicated by the own vehicle position information received from the connected car into a mesh ID, and aggregates the total number of automobiles for each mesh ID and for each unit time. Then, information of the mesh ID, the total number of automobiles, the date and time, and the day of the week is registered in the log database 31. The server 30 sequentially updates the log database 31. The unit time can be set to, for example, 10 seconds or the like, but is not limited thereto.

The date and time is expressed as, for example, “YYYY/mm/dd HH: MM: SS”. Here, “YYYY” represents year, “mm” represents month, “dd” represents day, “HH” represents hour, “MM” represents minute, and “SS” represents second. The day of the week is represented by “0” to “6” from Monday to Sunday, for example.

In addition, the size and shape of the mesh can be, for example, a square of 100 m×100 m, but are not limited thereto.

Note that the total number of automobiles may be counted based on the number of automobiles detected by a beacon installed on a road, instead of being counted based on the own vehicle position information collected from the connected car.

The determination unit 22 determines whether the occurrence of the traffic congestion is sudden for each mesh based on the acquired total number of automobiles for each mesh and unit time. Specifically, the determination unit 22 calculates the aggregation sudden index based on the total number of automobiles per mesh and per unit time, and determines whether the occurrence of the traffic congestion is sudden based on the calculated aggregation sudden index.

The notification unit 23 notifies the user of the occurrence of the traffic congestion.

Hereinafter, the aggregation sudden index will be described.

In the traffic congestion detection, in order to determine whether the total number of automobiles is suddenly larger than usual, an aggregation sudden index based on the total number of automobiles rather than the visit probability is defined. The aggregation sudden index R(l, t) is defined by the following expression.

$$ℛ ( l , t ) = {\sum }_{k} ω ( {t}_{k} , l ) \frac{C ( l , t ) - μ ( {t}_{k} , l )}{σ ( {t}_{k} , l )} \qquad ( 3 )$$

Here, tₖ represents time information such as a time zone and a day of the week at the time of classification by the time axis k of the calculation target of the aggregation sudden index R(l, t). For example, in a case where k=2 and the calculation target time zone of the aggregation sudden index R(l, t) is between 13:00 and 14:00, it is expressed as t₂=13.

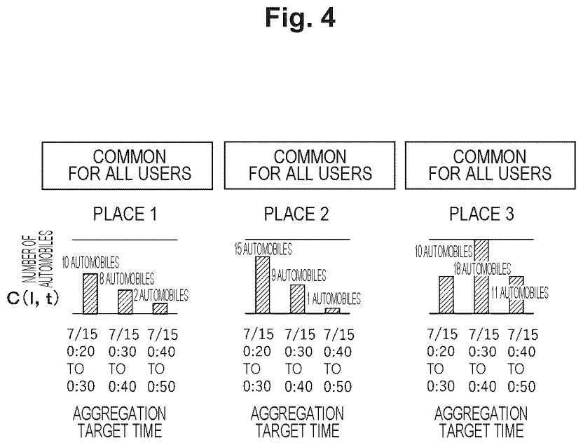

C(l, t) represents the total number of automobiles at the date and time t of the mesh l for which the aggregation sudden index R(l, t) is desired to be calculated. FIG. 4 illustrates an example of the total number of automobiles C(l, t) calculated for each place.

μ(tₖ, l) represents an average of the total number of automobiles in the time axis k including the date and time t for the mesh l. For example, in a case where the date and time t is 13:03 and k=2, t₂=13. Therefore, μ(t₂, l) represents an average of the total number of automobiles between 13:00 and 14:00 of the mesh l.

Similarly, σ(tₖ, l) represents the standard deviation of the total number of automobiles on the time axis k including the date and time t.

ω(tₖ, l) is a weight in the time zone tₖ of the time axis k for the mesh l, and is expressed by the following expression.

$$ω ( {t}_{k} , l ) = \frac{T ( {t}_{k} , l )}{{max}_{{t}_{k}^{′}} T ( {t}_{k}^{′} , l )} \qquad ( 4 )$$

Here, T(tₖ, l) indicates the total number of times of aggregation of the total number of automobiles of meshes l in the time zone tₖ.

$${max}_{{t}_{k}^{′}} T ( {t}_{k}^{′} , l )$$

represents the total number of times of aggregation in a time zone t′ₖ that is most aggregated in the entire time axis of the time zone tₖ for the mesh l. As described above, the time axis having a larger total number of times of aggregation has a larger weight.

In addition, w represents reliability on the time axis. Note that, when data in which there is little variation in the total number of times of aggregation depending on the time zone or day of the week and one or more vehicles are always present throughout the day is used, it is also conceivable to provide a threshold value for the number of automobiles to count the total number of times of aggregation. For example, in a case where the threshold value is 10 or more, the number of times of obtaining the counting result of 10 or more is stored in T(tₖ, l). In the time zone tₖ in which it is desired to calculate the aggregation sudden index, it is possible to increase the reliability of the time axis having a large number of times of learning at the time of occurrence of congestion to some extent and strongly consider the time axis at the time of calculating the final aggregation sudden index. Since the number of samples is smaller in the aggregation result at the time of occurrence of congestion than in the simple aggregation result, it is possible to strongly consider the value of the sudden index calculated on the reliable time axis among the time axes of various granularities by increasing the reliability of the time axis on which the periodic occurrence of congestion can be learned. By preparing a plurality of time axes having different granularities and outputting the weighted linear sum of the aggregation sudden indexes calculated from the time axes, it is possible to determine the degree of sudden occurrence using the unified index even if learning at the time of occurrence of congestion is insufficient. In particular, in the early stage of the spread of connected cars, if the ratio of connected cars is low at the time of occurrence of congestion, there is a case where periodic congestion cannot be correctly discriminated. Therefore, in such a case, the present disclosure can output the degree of sudden by adopting a coarser time axis if there is less learning data. For example, it can be considered that a time axis considering only the day of the week is a rough time axis as compared with a time axis such as “between 13:00 and 14:00 on Monday” considering the day of the week and the time zone.

Unlike Expression (1) above, the above value used for calculating the aggregation sudden index R(l, t) is a value that does not consider all the users u, and is a value related to the number of automobiles detected at the same place per unit time regardless of the users.

Note that, as shown in Expression (4) above, since the weight ω (tₖ, l) does not need to consider all the meshes l unlike Expression (2) above, the calculation of the aggregation sudden index R(l, t) can be performed independently for each mesh l. Therefore, in a case where it is necessary to calculate the aggregation sudden index in many places as in the case of traffic congestion detection, the calculation cost can be reduced.

From Expression (3) above, in a case where the total number of automobiles C(l, t) is larger than the average μ(tₖ, l) of the total number of automobiles, the aggregation sudden index R(l, t) is a value larger than 0, and the larger the difference from the average μ(tₖ, l), the larger the value of the aggregation sudden index R(l, t). In addition, in a case where the standard deviation σ(tₖ, l) representing the variation in the total number of automobiles C(l, t) is large, even if the total number of automobiles C(l, t) is larger than the average μ(tₖ, l), the aggregation sudden index C(l, t) does not become so large, but in a case where the standard deviation σ(tₖ, l) is small and the total number of automobiles C(l, t) is larger than the average μ(tₖ, l) of the total number of automobiles, the aggregation sudden index R(l, t) becomes large.

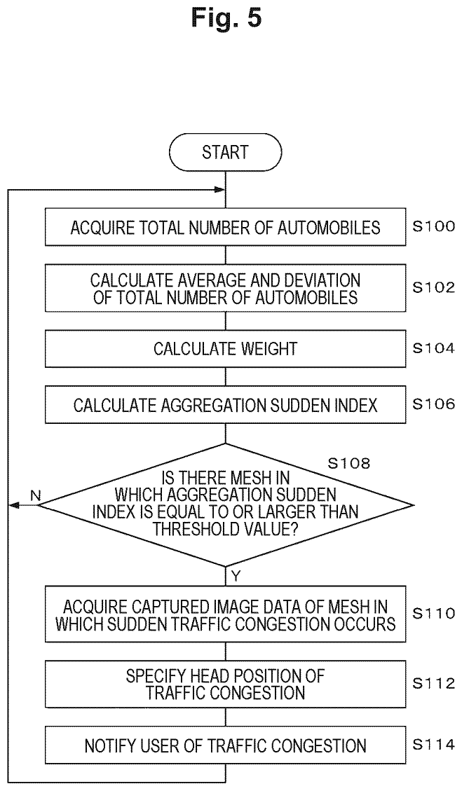

Next, the operation of the traffic congestion determination device 10 according to the present embodiment will be described with reference to FIG. 5.

FIG. 5 is a flowchart illustrating an example of a flow of traffic congestion determination processing by the traffic congestion determination program according to the present embodiment. The processing of the traffic congestion determination by the traffic congestion determination program is realized by the CPU 11 of the traffic congestion determination device 10 writing and executing the traffic congestion determination program stored in the ROM 12 or the storage 14 in the RAM 13.

In step S100, the CPU 11 acquires the total number of automobiles C(l, t) for each mesh l and for each unit time from the log database 31.

In step S102, the CPU 11 calculates the average μ(tₖ, l) and the standard deviation σ(tₖ, l) of the total number of automobiles for each mesh l and each time zone tₖ.

In step S104, the CPU 11 calculates a weight w(tₖ, l) for each mesh l and each time zone tₖ. Specifically, the total number of times of aggregation T(tₖ, l) of the total number of automobiles of the meshes l in the time zone tₖ is calculated. In addition, for each mesh l, the number of times of aggregation

$${max}_{{t}_{k}^{′}} T ( {t}_{k}^{′} , l )$$

in the time zone t′ₖ in which the total number of times of aggregation is the largest among all the time axes of the time zone tₖ is calculated. Then, the weight ω(tₖ, l) is calculated for each mesh l and each time zone tₖ by Expression (4) above.

Note that processing of steps S102 and S104 may not be executed every time. For example, the processing of steps S102 and S104 may be executed every predetermined time or every time the total number of automobiles is acquired a predetermined number of times.

In step S106, the CPU 11 calculates the aggregation sudden index at the current time t for each mesh l by Expression (3) above based on the calculation results of steps S100 to S104.

In step S108, the CPU 11 determines whether there is a mesh l equal to or larger than a threshold value among the aggregation sudden indexes R(l, t) of all the meshes l calculated in step S106, that is, whether there is the mesh l in which sudden traffic congestion has occurred. Then, in a case where there is a mesh l whose aggregation sudden index R(l, t) is equal to or greater than the threshold value, the processing proceeds to step S110, and in a case where there is no mesh l whose aggregation sudden index R(l, t) is equal to or larger than the threshold value, the processing proceeds to step S100. Note that the threshold value is set in advance to a value at which it is considered that there is a high possibility that sudden traffic congestion has occurred if the aggregation sudden index R(l, t) is equal to or greater than the threshold value.

In step S110, the CPU 11 acquires the captured image data from the automobile present in the mesh l in which the aggregation sudden index R(l, t) is equal to or greater than the threshold value, that is, the mesh l in which the sudden traffic congestion occurs. The captured image data may be acquired via the server 30 or may be acquired directly from the automobile. The captured image data may be a moving image or a still image.

In step 112, the CPU 11 analyzes the captured image data acquired in step S112 using a known analysis method, specifies a traffic congestion range, and specifies the head position of the traffic congestion. The reason why the head position of the traffic congestion is specified is that there is a possibility that the cause of the occurrence of the traffic congestion is recorded in the captured image of the head position of the traffic congestion. Note that specifying the head position of the traffic congestion is an example, and the present invention is not limited thereto. That is, it is sufficient to be able to specify the captured image in which the cause of the occurrence of the traffic congestion may be recorded, and for example, a boundary or the like at which the density of the vehicle changes may be specified as the cause of the occurrence of the traffic congestion. Examples of the boundary at which the density of the vehicle changes include the position of an accident vehicle and a construction site.

In step S114, the CPU 11 notifies the user by transmitting the captured image data of the head position of the traffic congestion specified in step S112 and the position information indicating the traffic congestion range. As a result, the user can recognize the cause of the occurrence of the traffic congestion together with the position of the traffic congestion range. Note that the users to be notified may be all users, or may be only users in a predetermined area centered on a mesh in which sudden traffic congestion has occurred. The predetermined area can be, for example, an area within a radius of several hundred meters or within several kilometers around a mesh in which sudden traffic congestion occurs, but is not limited thereto.

As described above, in the present embodiment, only the captured image data of the mesh l in which the aggregation sudden index R(l, t) is equal to or greater than the threshold value is acquired for each mesh l, and the captured image data of the head position of the traffic congestion and the position information indicating the traffic congestion range are transmitted to the user to be notified. As a result, the calculation cost for analyzing the captured image data can be suppressed.

In the present embodiment, the case where the captured image data of the mesh l having the aggregation sudden index R(l, t) less than the threshold value is not acquired has been described, but the present invention is not limited thereto. For example, the priority may be given such that the priority becomes higher as the aggregation sudden index R(l, t) becomes larger, and even in a case where the aggregation sudden index R(l, t) is small and the priority of acquiring the captured image data is low, the captured image data may be acquired and the processing of steps S110 to S114 may be executed in a case where there is room for processing such as analysis of the captured image data.

In addition, a case where a predetermined value is used as the threshold value in step S108 has been described, but the present invention is not limited thereto. For example, the threshold value may be automatically determined using a method such as a receiver operating characteristic (ROC) curve. In this case, since there are no upper limit and lower limit in the aggregation sudden index R(l, t), the maximum value may be normalized to 1.0, the minimum value may be normalized to −1.0, and the like. This can generalize the determination of the threshold value.

Note that, in the present embodiment, the case where the user is notified when there is a mesh whose aggregation sudden index is equal to or greater than the threshold value has been described. However, the calculated aggregation sudden index may be used for other processing. For example, in automobile route search processing, the aggregation sudden index may be used as one of parameters for determining a route to a destination.

In addition, an aggregation sudden index calculated based on the total number of automobiles may be used as an evaluation for city planning. A place where traffic congestion occurs suddenly may cause temporary congestion due to a sudden cause such as an accident, or may cause a new traffic congestion due to opening of a new road or a new facility. In particular, since a place where the aggregation sudden index increases once and then decreases is a place that causes new chronic traffic congestion due to a change in road conditions, it is considered that it is necessary to take measures such as increasing the number of lanes and allocating personnel for vehicle arrangement.

In addition, the use of the aggregation sudden index is not limited to the evaluation of traffic congestion. For example, by being applied to the statistical information of the flow of people, a place where people are suddenly crowded can be detected, and can be used to determine a destination to which a police officer of personnel reduction is assigned or to guide the flow of people to another place. In addition, when the aggregation sudden index is applied to the transmission amount of the network, it is possible to extract a phenomenon in which the transmission amount suddenly increases or decreases in consideration of a plurality of time axes, and it is considered to be useful for failure detection of the network device. Similarly, the present invention can also be applied to power consumption and the like, and for example, it is also conceivable to use a case where a malfunction of a machine is suspected when the consumption rapidly increases in a home for an elderly person, and a case where a physical condition is suspected of being abnormal when the consumption rapidly decreases. As described above, periodicity in a plurality of time axes is assumed, and it is possible to apply the aggregation sudden index to the overall time-series log data in which the “amount” is recorded. In particular, in a case where learning data having an abnormal value is insufficient, it is expected that the effect is greatly exhibited when it is desired to perform calculation of the index in a wide range at a high speed.

### Second Embodiment

A second embodiment will be described. The same parts as those of the first embodiment are denoted by the same reference numerals, and a detailed description thereof will be omitted.

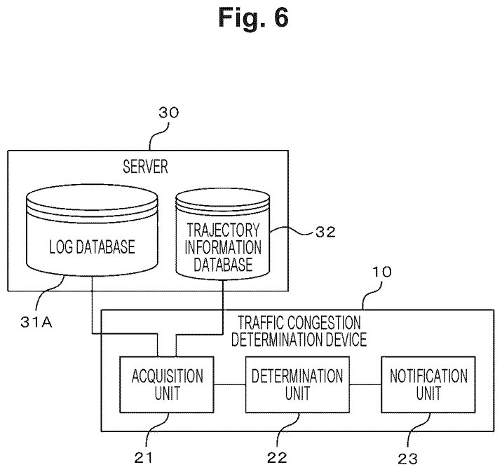

As illustrated in FIG. 6, a functional configuration of traffic congestion determination device 10 according to the second embodiment is the same as that of the traffic congestion determination device 10 illustrated in FIG. 3 described in the first embodiment, but processing of each unit is different. First, contents of data acquired by the acquisition unit 21 from the server 30 and processing contents are different.

The server 30 includes a log database 31A and a trajectory information database 32.

In addition to the contents of the log database 31A described in the first embodiment, the log database 31 includes a user ID for identifying the user u representing the automobile that has transmitted the host vehicle position information to the server 30.

In the trajectory information database 32, for example, trajectory information representing a past traveling trajectory recorded by an automobile such as a taxi equipped with a GPS device is recorded for the number of a plurality of automobiles, that is, for a plurality of users, in the same format as the log database 31A.

The acquisition unit 21 acquires the total number of automobiles for each mesh and for each unit time. Note that the detected traffic congestion information may be acquired. In addition, the acquisition unit 21 further acquires the trajectory information of the automobile from the trajectory information database 32.

The determination unit 22 calculates the traffic congestion habit degree based on the congestion occurrence probability calculated based on the total number of automobiles for each mesh and unit time. For example, the traffic congestion habit degree is calculated based on the congestion occurrence probability calculated based on a case where the total number of automobiles is larger than a certain number for each mesh and unit time or a case where traffic congestion for each lane is detected by image processing. Then, the determination unit 22 calculates a trajectory habit degree on the basis of the passage probability based on the trajectory information, calculates a weighted traffic congestion habit degree based on the traffic congestion habit degree, the trajectory habit degree, and the weight of the trajectory habit degree, and determines whether the occurrence of the traffic congestion is sudden or chronic based on the calculated weighted traffic congestion habit degree.

For example, the determination unit 22 increases the weight of the trajectory habit degree as the number of meshes for which the traffic congestion habit degree is not calculated increases. In particular, in a case where the information at the head and the tail of the traffic congestion detected by the image processing of the captured image data is used for the calculation of the traffic congestion occurrence probability instead of whether the total number of automobiles is equal to or greater than the threshold value, it is considered that the cost for the detection of the traffic congestion is large, so that the number of meshes for which the traffic congestion habit degree is not calculated increases, and the effect of the technology of the present disclosure increases. In addition, even in a case where the traffic congestion is determined based on whether the total number of automobiles is equal to or greater than the threshold value, occurrence of the traffic congestion cannot necessarily be detected from the information of the total number of automobiles in the period from the early stage of spread of connected cars to the period of spread and expansion of connected cars, and thus there is a possibility that a mesh having traffic congestion habit degree not yet calculated will appear.

The notification unit 23 notifies only users who satisfy a predetermined criterion of occurrence of the traffic congestion. For example, in a case where the traffic congestion occurs chronically, the predetermined criterion is that the living area of the user does not include the predetermined area including the mesh in which the chronic traffic congestion occurs.

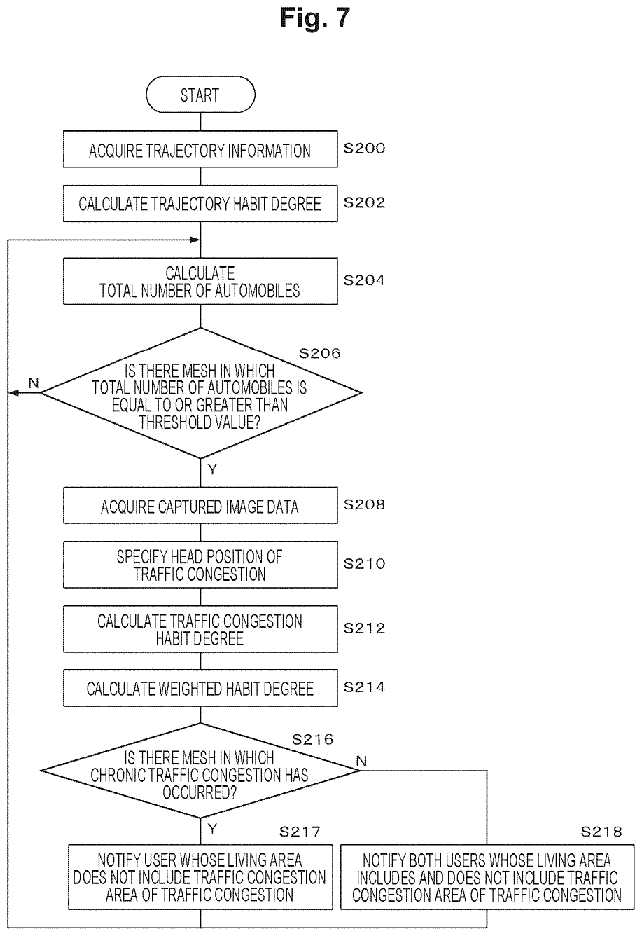

Next, the operation of the traffic congestion determination device 10 according to the present embodiment will be described with reference to FIG. 7.

FIG. 7 is a flowchart illustrating an example of a flow of traffic congestion determination processing by the traffic congestion determination program according to the present embodiment. The processing of the traffic congestion determination by the traffic congestion determination program is realized by the CPU 11 of the traffic congestion determination device 10 writing and executing the traffic congestion determination program stored in the ROM 12 or the storage 14 in the RAM 13.

In step S200, the CPU 11 acquires the trajectory information from the trajectory information database 32 of the server 30.

In step S202, the CPU 11 calculates the trajectory habit degree using the method disclosed in Patent Literature 1 based on the trajectory information acquired in step S200. That is, the trajectory habit degree R1(l, t) is calculated by Expression (1) above. Here, the user u is not distinguished, and the trajectory habit degree R1(l, t) is calculated in common for all users.

Specifically, a passage probability P(l|tₖ) of crossing all users to the mesh l in the time zone tₖ is calculated for each mesh l and each time zone tₖ based on the trajectory information.

In addition, the average μ(tₖ) of the passage probabilities for all the meshes l crossing all the users in the time zone tₖ is calculated for each time zone tₖ.

In addition, the standard deviation G(tₖ) of the passage probabilities for all the meshes l crossing all the users in the time zone tₖ is calculated for each time zone tₖ.

In addition, the total value N(u, tₖ) of the number of times of passage of all places by all users crossing in the time zone tₖ is calculated for each time zone tₖ.

In addition, the total value of the number of times of passage at all places

$${max}_{{t}_{k}^{′}} N ( {t}_{k}^{′} )$$

in the time zone tₖ′ in which the most passes are recorded among all the time zones of the time zone tₖ across all users is calculated for each time zone tₖ.

Then, the trajectory habit degree R1(l, t) is calculated as the mesh l by Expression (1) above.

In step S204, the CPU 11 acquires the total number of automobiles C(l, t) per mesh l and per unit time or the presence or absence of the traffic congestion from the log database 31A.

In step S206, the CPU 11 determines whether there is a mesh l whose total number of automobiles C(l, t) is equal to or greater than the threshold value. In a case where the total number of automobiles C(l, t) is equal to or greater than the threshold value, the threshold value is set to a value with which it can be determined that there is a high possibility that traffic congestion has occurred in the mesh l. Then, if there is the mesh I whose total number of automobiles C(l, t) is equal to or greater than the threshold value, the processing proceeds to step S208, and if there is no mesh l whose total number of automobiles C(l, t) is equal to or greater than the threshold value, the processing proceeds to step S204. In addition, in a case where the traffic congestion detection result by the image processing of the captured image data is input, the processing proceeds to step S208 in a case where there are one or more traffic congestion detection results, and the processing proceeds to step S204 in a case where there is no traffic congestion detection result.

In step S208, the captured image data is acquired from the user u who exists in the mesh l in which the total number of automobiles C(l, t) is greater than or equal to the threshold value, that is, the user u of the automobile that has transmitted the log data to the server 30 from the mesh l in which the total number of automobiles C(l, t) is greater than or equal to the threshold value.

In step S210, similarly to step 112 in FIG. 5, the CPU 11 analyzes the captured image data acquired in step S208, specifies a traffic congestion range, and specifies the head position of the traffic congestion.

In step S212, the CPU 11 calculates the traffic congestion habit degree R2(l, t) for each mesh l by Expression (1) above based on the log data registered in the log database 31A. However, here, the user u is not distinguished, and the traffic congestion habit degree R2(l, t) is calculated in common for all users. In this case, P(l|t)) represents the congestion occurrence probability. The calculation of the traffic congestion habit degree R2 (l, t) is similar to the calculation of the trajectory habit degree R1(l, t) in step S202 except that the log data registered in the log database 31A is used, and thus the description thereof is omitted.

In step S214, the weighted habit degree R3(l, t) is calculated by the following expression based on the trajectory habit degree R1(l, t) calculated in step S202 and the traffic congestion habit degree R2(l, t) calculated in step S212.

R3(l,t)=R2(l,t)+R1(l,t)×α (5)

In Expression (5) above, α is a weight and is expressed by the following expression.

α=c×M^{1/s}×b (6)

Here, c is a correlation coefficient between the trajectory habit degree R1(l, t) and the traffic congestion habit degree R2(l, t). M is the number of meshes l in which the traffic congestion habit degree R2(l, t) is not calculated, that is, the number of meshes l in which the number equal to or greater than the threshold value is not detected or the traffic congestion is not detected by the traffic congestion detection using the image and the traffic congestion habit degree R2(l, t) is not calculated. a and b are constants.

From Expression (6) above, the larger the correlation coefficient c, that is, the smaller the difference between the trajectory habit degree R1(l, t) and the traffic congestion habit degree R2(l, t), the larger the weight a. In addition, the larger the number M of meshes l for which the traffic congestion habit degree is not calculated, the larger the weight a becomes.

Therefore, in the weighted habit degree R3(l, t), as the difference between the trajectory habit degree R1(l, t) and the traffic congestion habit degree R2(l, t) is smaller, the influence of the trajectory habit degree R1(l, t) is larger than that of the traffic congestion habit degree R2(l, t). In addition, as the number M of undetected meshes l is larger, the influence of the trajectory habit degree R1(l, t) is larger than the traffic congestion habit degree R2(l, t).

Note that, in a case where the number of log data pieces is small, the variation in the weighted habit degree R3(l, t) tends to be large. Therefore, the weighted habit degree R3(l, t) may be normalized and classified into levels such as levels 1 to 10.

In addition, in a case where the mesh l for which the traffic congestion habit degree R2(l, t) has been calculated has increased to some extent, the influence of the number M of meshes l for which the traffic congestion habit degree R2(l, t) has not been calculated may be suppressed by setting the constant a to a large value. That is, the influence of the trajectory habit degree R1(l, t) may be reduced.

In addition, regarding the constant b, in a case where the correlation coefficient C between the trajectory habit degree R1(l, t) and the traffic congestion habit degree R2(l, t) is small, and in a case where the number of log data pieces is too small, the constant b may be set to a value less than 1, and the weight a may be reduced. That is, the influence of the trajectory habit degree R1(l, t) may be reduced.

In step S216, the CPU 11 determines whether there is a mesh l in which chronic traffic congestion has occurred. Specifically, it is determined whether the weighted habit degree R3(l, t) calculated in step S214 is greater than or equal to a predetermined threshold value. In a case where the weighted habit degree R3(l, t) is equal to or greater than the threshold value, the threshold value is set to a value with which it can be determined that the traffic congestion occurring at the mesh l and the time t is highly likely to be chronic.

Then, in a case where there is a mesh l in which chronic traffic congestion has occurred, that is, in a case where there is a mesh in which the weighted habit degree R3(l, t) is equal to or greater than the threshold value, the processing proceeds to step S21⁷. On the other hand, in a case where there is no mesh l in which chronic traffic congestion has occurred, that is, in a case where there is no mesh in which the weighted habit degree R3(l, t) is equal to or greater than the threshold value, the processing proceeds to step S218.

In step S217, the CPU 11 notifies the user u whose living area does not include the predetermined area including the mesh in which the chronic traffic congestion has occurred by transmitting the captured image data of the head position of the traffic congestion specified in step S210 and the position information indicating the traffic congestion range. That is, the occurrence of the chronic traffic congestion is not notified to the user u whose living area includes the area including the mesh in which the chronic traffic congestion occurs. Note that the predetermined area can be an area within a radius of several hundred meters or a radius of several kilometers around a mesh in which chronic traffic congestion occurs, or the like, but is not limited thereto.

In step S218, the CPU 11 notifies both the user whose living area does not include the predetermined area and the user whose living area is the predetermined area that the sudden traffic congestion has occurred.

Whether the predetermined area including the mesh in which the chronic traffic congestion has occurred is within the living area may be determined based on, for example, the habit degree calculated by the method described in Patent Literature 1, or may be determined based on the distance from the location of the house to the current location estimated based on the history of the location information.

In this way, it is determined whether the generated traffic congestion is chronic or sudden based on the weighted traffic congestion habit degree R3(l, t), and in a case where the traffic congestion is chronic, the occurrence of the traffic congestion is not notified to a user whose living area includes a predetermined area including a mesh in which the traffic congestion occurs. As a result, it is possible to suppress unnecessary notification of occurrence of traffic congestion. On the other hand, in a case where the traffic congestion has occurred suddenly, notification is given to all users regardless of whether or not the living area of the user includes the predetermined area. This is because the sudden traffic congestion is not recognized by the user whose living area includes the predetermined area, and there is a high possibility of causing an accident.

Note that, in the present embodiment, a case has been described in which, when there is a mesh whose weighted traffic congestion habit degree is equal to or greater than the threshold value, the occurrence of chronic traffic congestion is notified to a user whose living area does not include the predetermined area including the mesh. However, the calculated weighted traffic congestion habit degree may be used for other processing. For example, in route search processing of an automobile, a weighted traffic congestion habit degree may be used as one of parameters for determining a route to a destination.

In addition, the calculated weighted traffic congestion habit degree, the calculated date and time, and the mesh ID are recorded, and when the date and time and the mesh ID are input, the weighted traffic congestion habit degree may be used for processing of outputting whether the traffic congestion occurred in the mesh of the mesh ID is chronic or sudden.

Note that, for example, information of a database for accumulating traffic congestion information common to all lanes on one side that is not for each lane may be used as log data used for calculating the traffic congestion habit degree. Furthermore, it is also conceivable to utilize a visit tendency in another similar service as external information when it is desired to confirm a visit tendency of a user in a newly started location information recording service, in addition to log data of traffic congestion.

### EXAMPLES

Examples of the disclosed technology will be described.

Hereinafter, the method of calculating the habit degree disclosed in Patent Literature 1 is referred to as regular behavior measure (RBM), the method of calculating the aggregation sudden index in the first embodiment is referred to as SICM as described above, and the method of calculating the weighted habit degree in the second embodiment is referred to as small-start regular behavior measure (SRBM).

### (Outline of Trajectory Information)

The following GPS log data of a taxi was used as the trajectory information.
Period: 66 days from Nov. 27, 2017 to Jan. 31, 2018
Number of automobiles: 10 taxies
Total number of logs: 2,757,003
Number of meshes: 47,146

Regarding the latitude and longitude of the GPS log data, four digits after the decimal point are rounded, and up to three digits after the decimal point are set as the number of significant digits. The mesh was a square mesh of about 110 m in length and width.

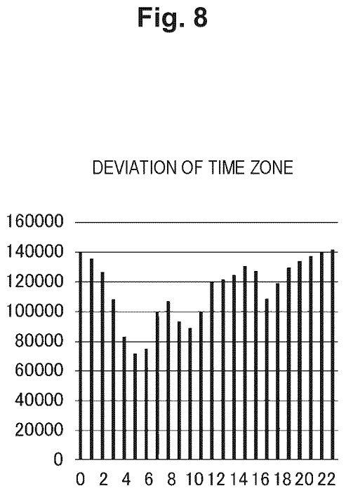

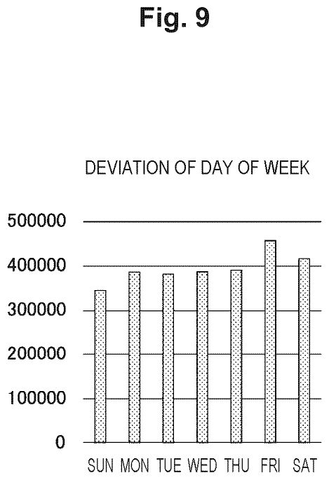

FIG. 8 illustrates a graph indicating the deviation of the time zone of the GPS log data. The horizontal axis represents time, and the vertical axis represents the number of logs. In addition, FIG. 9 illustrates a graph indicating the deviation of the day of the week of the GPS log data. The horizontal axis represents the day of the week, and the vertical axis represents the number of logs. As illustrated in FIGS. 8 and 9, the deviation in the number of logs was small in both the time zone and the day of the week.

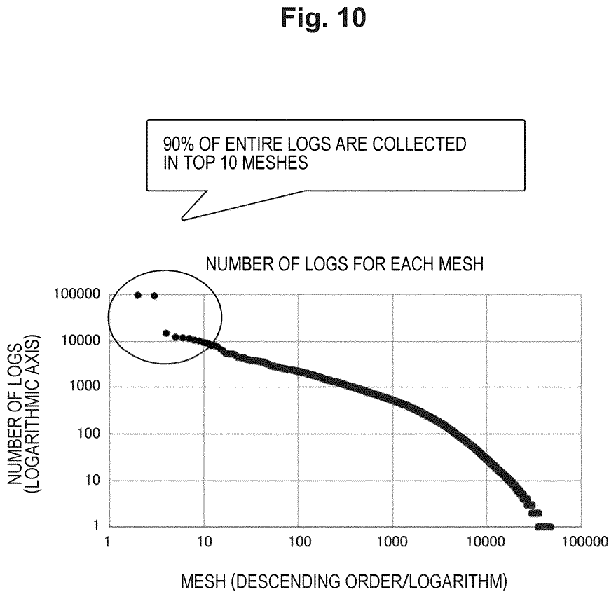

In addition, FIG. 10 illustrates a graph of the number of logs representing the number of pieces of log data for each mesh. FIG. 10 plots the number of logs of each mesh in descending order of the number of logs. As illustrated in FIG. 10, it has been found that 90, of the entire GPS log data is collected in the top 10 meshes.

### (Validation of RBM)

Since the RBM has been devised as a method assuming a human check in log, it has been confirmed whether it is possible to adapt to continuous log data acquired by a GPS device mounted on an automobile or whether there is a habit depending on a plurality of time axes considered by the RBM regarding traffic congestion of the automobile. From the GPS log data of 10 cars, the passage probability was calculated without distinguishing which log data of the automobile was. Originally, in the second embodiment, a place where the total number of automobiles is equal to or greater than the threshold value is input, or traffic congestion occurrence place detected in the image processing of the captured image data is input, but there is a case where only 10 automobiles have GPS log data, and first, the habit degree by the RBM is calculated based on whether a taxi has passed through each mesh based on the GPS log data.

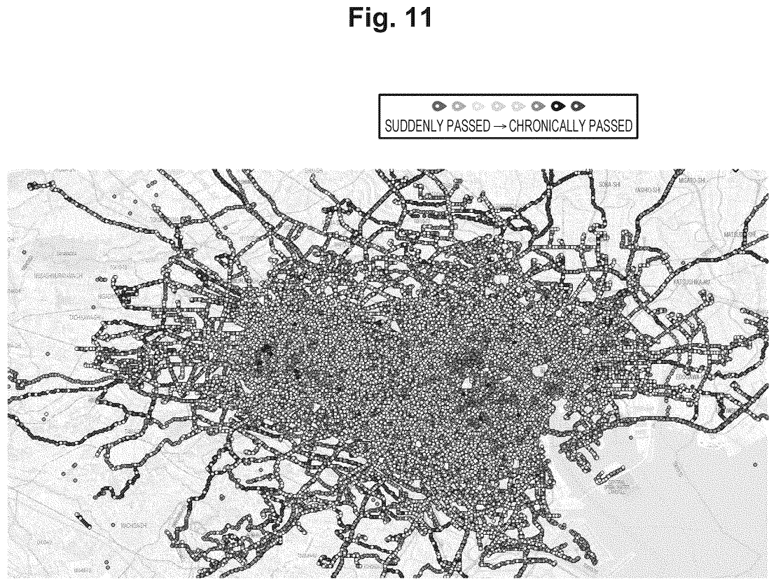

FIG. 11 illustrates a result of applying the RBM to GPS log data of a taxi. The habit degree was classified by the average value of the habit degree in each mesh. It was confirmed that places with high habit degree were scattered in the vicinity of Musashino City, Tokyo, which is a base of a taxi company, and in Tokyo, and that there were places with low habit degree indicating sudden visit as the distance from Tokyo increased.

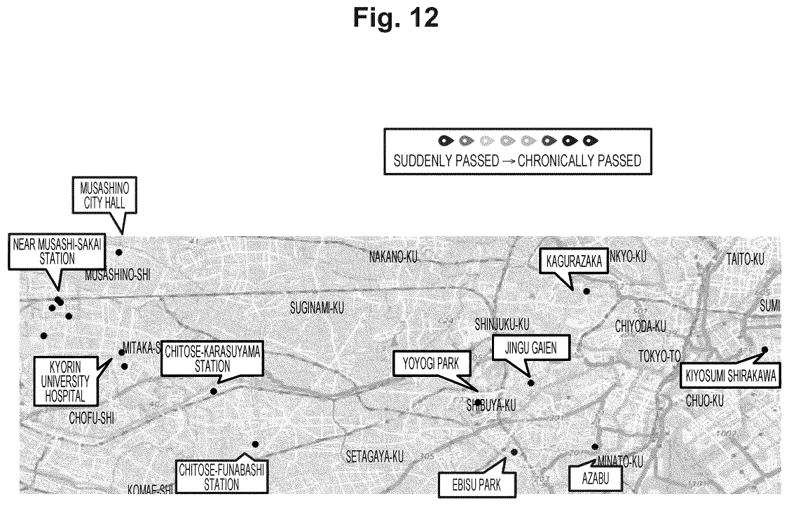

FIG. 12 illustrates a plot of only a place where the habit degree was particularly high, that is, a place where people passed through chronically. It was found that there was a chronic traffic congestion at a station, a park in Tokyo, which is considered to be a nap/standby place, or the like.

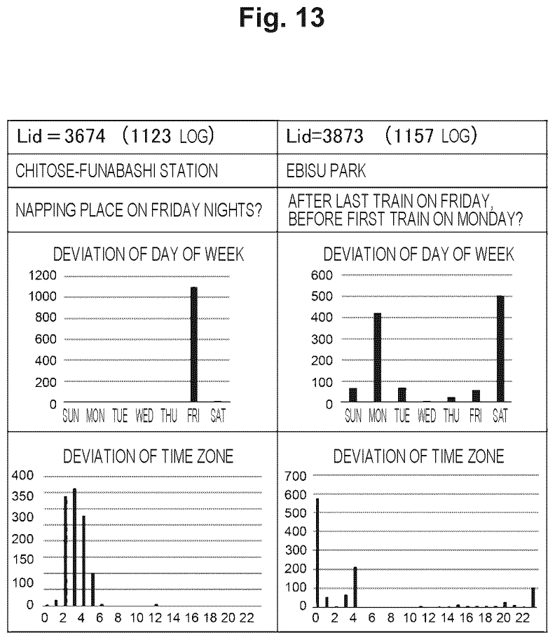

FIG. 13 illustrates a graph illustrating deviation of the day of the week and the time zone of a place where the number of logs is small but the habit degree is particularly high. It can be seen that the place of Lid=3674 which is the mesh ID (Chitose-Funabashi Station) has a large number of logs at midnight on Friday, and there is a large deviation in the day of the week and the time zone.

In the place of Lid=3873 (Ebisu Park), the number of logs in the time zone after the last train on Friday and before the start of the train on Monday is large, and it is considered that both of them show a tendency peculiar to a taxi that travels aiming at obtaining customers in the time zone in which trains are not in operation.

As described above, by not only considering just number of logs but also calculating the habit degree in consideration of a plurality of time axes by RBM, it has been confirmed that a place where the deviation of the day of the week and the time zone is large can be specified although the number of logs is not necessarily large.

In addition, it has been found that RBM is effective for indexing whether traffic congestion is chronic or sudden from trajectory information obtained by the GPS.

### (Validation of SICM)

The GPS log data of the taxi was used to confirm validity of SICM.

Originally, a sudden traffic congestion is determined by using the total number of automobiles per unit time of each mesh as an input, but the number of logs of the GPS log data in the mesh every 10 minutes was used as an input of SICM when evaluating the validity of SICM using the GPS log data of 10 taxies.

In a mesh in which traffic congestion has occurred, the time during which an automobile stays in the mesh becomes long, and the number of logs of GPS log data periodically acquired increases. Therefore, in order to simply evaluate the validity of SICM, evaluation was performed using the number of logs of GPS log data.

The total number of times of aggregation when the GPS log data was counted every 10 minutes was 9,258. In addition, the total number of times of aggregation in all the meshes, that is, the total number of times of calculation of the aggregation sudden index was 1,016,024 times.

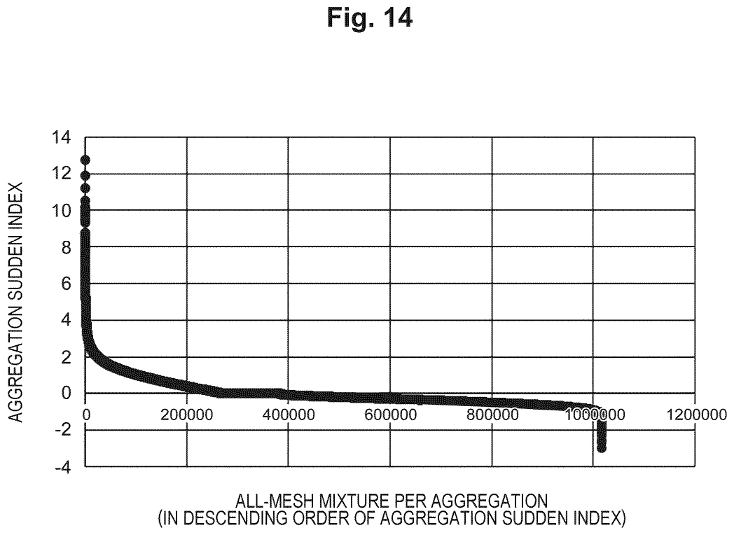

FIG. 14 illustrates a distribution of an aggregation sudden index calculated by the SICM. FIG. 14 plots the aggregation sudden indices of all meshes in descending order of the aggregation sudden indices. In the first aggregation, since the aggregation sudden index of all the meshes is zero, there are many aggregations in which the aggregation sudden index is exactly zero. In addition, there may be a case where the aggregation sudden index is a positive value, that is, a case where the total number of automobiles is suddenly larger than usual, or there may be a case where the aggregation sudden index is a negative value, that is, a case where the total number of automobiles is suddenly smaller than usual. It can be seen that the total number of automobiles is larger in a case where the total number of automobiles is suddenly larger than usual than in a case where the total number of automobiles is suddenly smaller than usual, and it can be seen that the total number of automobiles is less likely to suddenly decrease in a place where traffic congestion occurs chronically.

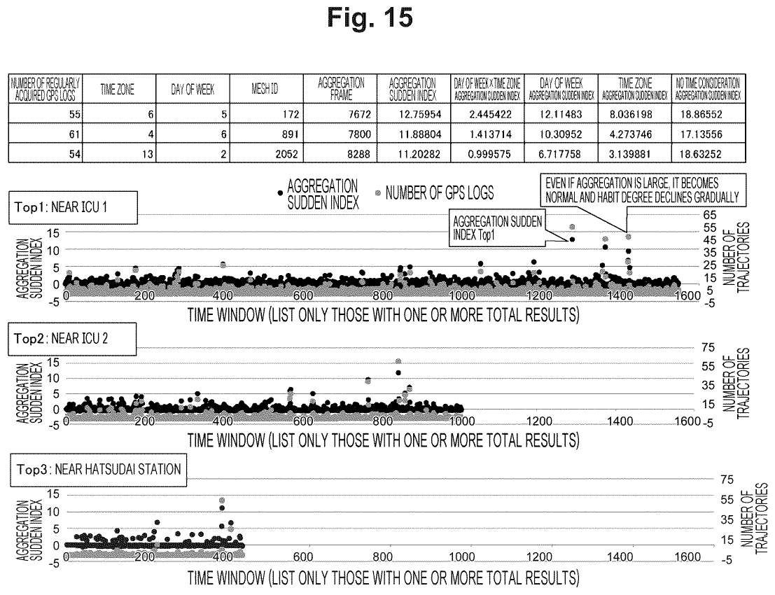

In FIG. 15, transitions in the aggregation sudden index and the number of logs are plotted for the three places with the highest aggregation sudden index. Top1 (near International Christian University (ICU) 1) is a place where the number of logs is usually not large, and it was confirmed that the aggregation sudden index reached the maximum when the number of logs suddenly became 50 or more. In addition, there are two timings at which the number of logs becomes 40 or more thereafter, but it can be seen that the aggregation sudden index is not so large at the third timing at which the number of logs increases although the number of logs is larger than the second timing at which the number of logs increases. When there are several results in which the aggregation sudden index suddenly becomes large, it is not so rare that the aggregation sudden index is large. Therefore, it can be considered said that the calculation result of the aggregation sudden index by the SICM is appropriate.

Similarly, with respect to places of Top2 (near International Christian University (ICU) 2) and Top3 (near Hatsudai Station), when the total number of automobiles suddenly increased more than usual, the total aggregation sudden index was large, and it could be confirmed that intended results were obtained.

Next, the effect of reducing the calculation cost in a case where the aggregation sudden index is calculated using the static aggregation statistical information will be described. Note that the aggregation statistical information is information including an average μ(tₖ, l) of the total number of automobiles, a standard deviation σ(tₖ, l) of the total number of automobiles, and a weight W(tₖ, l) in Expression (3) above.

In a case where the aggregation statistical information was created using the GPS log data for the first half 33 days of the 66 days, and the aggregation sudden index was calculated using the created static aggregation statistical information for the second half 33 days, the calculation time was 1.90 seconds. On the other hand, the calculation time in a case where the aggregation sudden index was calculated using the dynamic aggregation statistical information obtained by updating the aggregation statistical information every time in all 66 days was 6.37 seconds. It was confirmed that the calculation cost can be suppressed by calculating the aggregation sudden index using the static aggregation statistical information. In addition, in order to transmit the traffic congestion information to the user at high speed, it is necessary to perform the processing of prioritizing the captured image data of the image processing target at high speed, but it has been confirmed that the prioritization can be realized at high speed as compared with the case of performing abnormal value detection using a model such as Auto Encorder.

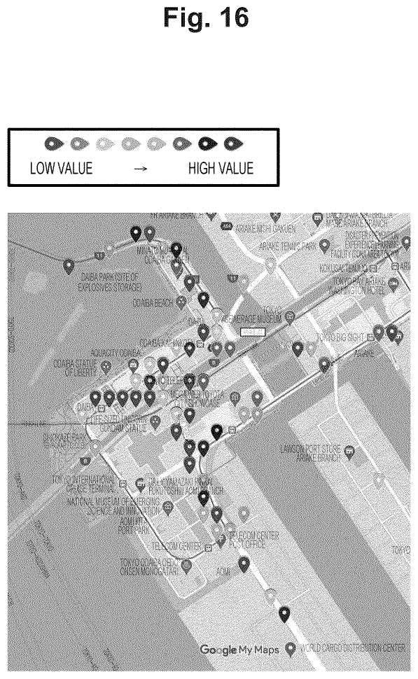

FIG. 16 illustrates 160 places where the aggregation sudden index was 1.0 or more, plotted on a map by dividing the calculated aggregation sudden index into 8 levels. In a case where the aggregation sudden index is calculated a plurality of times with the same mesh, a mark is displayed in an overlapping manner. As illustrated in FIG. 16, it has been confirmed that the automobiles are concentrated on roads with a large number of lanes, particularly near intersections. This coincides with a place where traffic congestion is likely to occur.

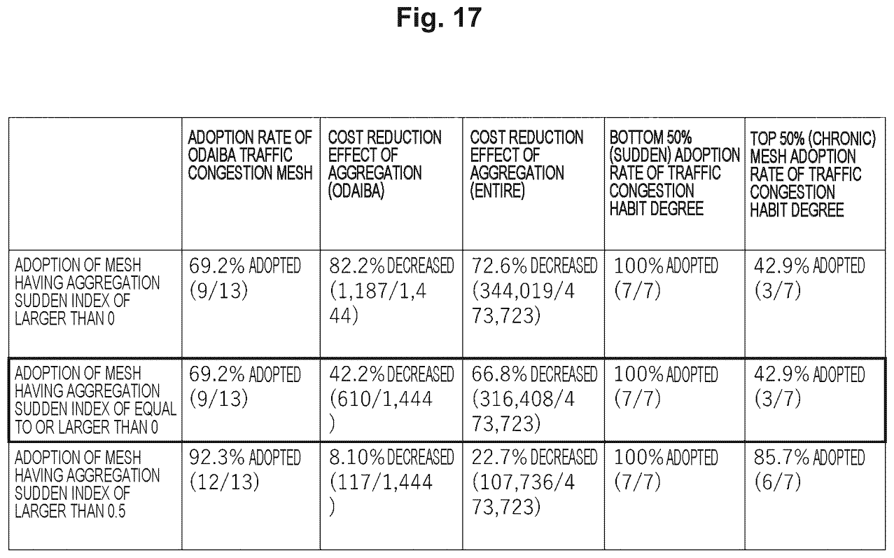

FIG. 17 illustrates the adoption rate and the reduction rate of the calculation cost with respect to the mesh in which the traffic congestion has actually occurred in each case of a case of adopting the mesh in which the aggregation sudden index is larger than 0, a case of adopting the mesh in which the aggregation sudden index is equal to or larger than 0, and a case of adopting the mesh in which the aggregation sudden index is larger than −0.5, in the case where the aggregation sudden index is calculated for each mesh using the dynamic aggregation statistical information.

Note that the mesh in which the traffic congestion actually occurred was manually detected in an area near Odaiba, and 121 meshes in which the traffic congestion actually occurred were detected.

In a case where a mesh whose aggregation sudden index is larger than 0 is adopted, it can be found that the reduction rate of the calculation cost in Odaiba is 82.2%, and 100% is adopted for a mesh with sudden traffic congestion.

In addition, in both the case of adopting the mesh having the aggregation sudden index of equal to or larger than 0 and the case of adopting the mesh having the aggregation sudden index of equal to or larger than −0.5, the reduction rate of the calculation cost is slightly reduced, but all the meshes having sudden traffic congestion are adopted.

On the other hand, it has been confirmed that the adoption rate of the mesh of the chronic traffic congestion that is desired to be excluded from the processing target of the acquisition and analysis of the captured image data is low, and the result matching the purpose of setting only the sudden traffic congestion as the target of the acquisition and analysis of the captured image data is obtained. Note that the traffic congestion habit degree of the traffic congestion detected manually was calculated using RBM, and the top 50% of the traffic congestion habit degree was regarded as chronic traffic congestion, and the bottom 50% was regarded as sudden traffic congestion.

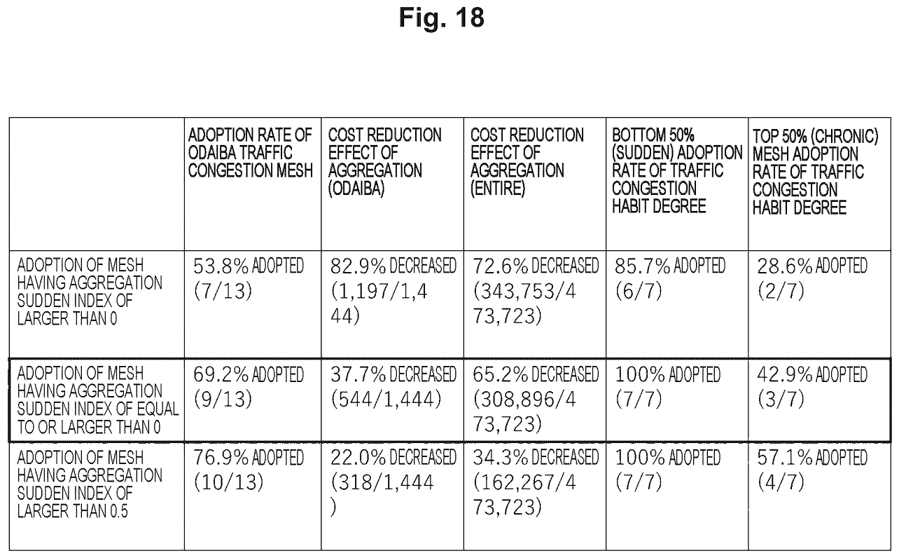

FIG. 18 illustrates a result in a case where the static aggregation statistical information calculated using only the GPS log data of the first half of 66 days is used. The result of FIG. 18 is different from the case of FIG. 17 only in that static aggregation statistical information is used.

As illustrated in FIG. 18, when only the mesh having the aggregation sudden index of larger than 0 was adopted, the adoption rate of the mesh with sudden traffic congestion decreased to 85.7%, but when the mesh having the aggregation sudden index of equal to or larger than 0 was adopted, 100% of the mesh with sudden traffic congestion was adopted, and the calculation cost reduction rate was 37.7% in Odaiba and 65.2% in the entire region.

As described above, even in a case where the calculation cost is suppressed using the static aggregation statistical information, it can be confirmed that the accuracy of the determination of the sudden traffic congestion does not decrease so much.

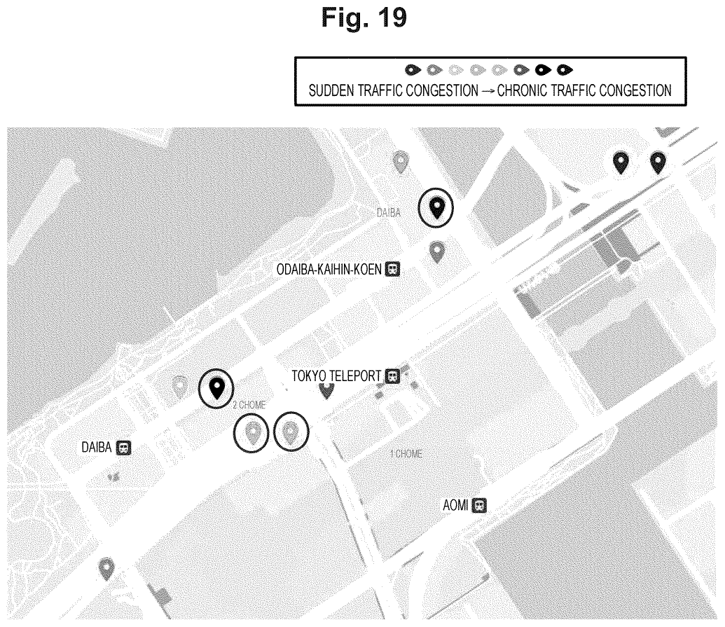

FIG. 19 illustrates a result of calculating traffic congestion habit degree using RBM for a mesh whose aggregation sudden index calculated using GPS log data for the last 33 days is equal to or higher than a threshold value. The traffic congestion habit degrees were divided into 8 levels. In addition, the four circled meshes were excluded when calculating the traffic congestion habit degree because the aggregation sudden index was less than the threshold value. However, since these were chronic traffic congestion with a high traffic congestion habit degree due to the RBM, it was confirmed that the purpose of acquiring and analyzing the captured image data only for meshes with the aggregation sudden index equal to or larger than a threshold value is met.

### (Validation of SRBM)

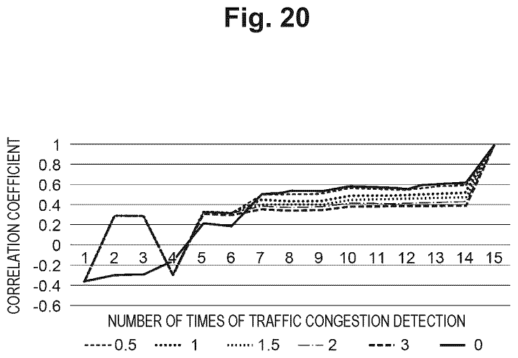

FIG. 20 illustrates a result of calculating, for all meshes, a correlation coefficient between a weighted habit degree calculated by SRBM every time traffic congestion is detected for 15 traffic congestions detected in Odaiba and a traffic congestion habit degree calculated by RBM after all 15 traffic congestions are detected.

Note that the constant a at the time of calculating the weighted habit degree was set to 1 because the number of times of traffic congestion detection was small. In addition, the constant b was changed in increments of 0.5 among 0 to 3. In a case where the constant b is zero, the trajectory habit degree is not considered, which is the same as when the traffic congestion habit degree is calculated by the RBM.

As illustrated in FIG. 20, in a case where the constant b is set to any value larger than zero, it has been confirmed that there is a high correlation until the first four traffic congestion are detected as compared with the case where the constant b is set to zero, that is, the case where the trajectory habit degree is not considered. If the value of the constant b is made too large, the correlation with the traffic congestion habit degree by the RBM becomes slightly low in the latter half, so that the constant b of 0.5 is considered to be most appropriate.

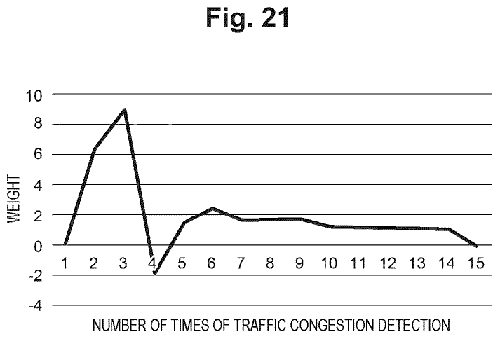

FIG. 21 illustrates a change in a weight a when the weighted traffic congestion habit degree is calculated. As illustrated in FIG. 21, it has been confirmed that the weight increases so that the influence of the trajectory habit degree increases at the initial stage where the number of times of traffic congestion detection is small.

By calculating the weighted traffic congestion habit degree using the SRBM, it was confirmed that a value close to the traffic congestion habit degree calculated by the RBM can be obtained after the traffic congestion detection result is sufficiently obtained even in the initial stage where the number of times of traffic congestion detection is small.

The above embodiment merely exemplarily describes the configuration example of the present disclosure. The present disclosure is not limited to the specific forms described above, and various modifications can be made within the scope of the technical idea.

For example, in the above embodiment, the automobile and the traffic congestion have been described as examples, but the present invention is not limited thereto. For example, a human may be used instead of an automobile, and a density of a human may be used instead of the traffic congestion. With such a configuration, for example, by notifying a user satisfying a predetermined condition of an area where the density of people is suddenly high or an area where the density of people is low, it is assumed that it is helpful for decision making such as going out at a timing when the density of people is low.

As the image having high density, for example, an image captured by a mobile device represented by a smartphone may be used, or an image posted on the SNS at a corresponding position/time may be used. Information such as mobile spatial statistics may be used in addition to the means described above to obtain the density of a person.

Traffic congestion determination processing that is executed by the CPU reading software (program) in the above embodiment may be executed by various processors other than the CPU. Examples of the processors in this case include a programmable logic device (PLD) whose circuit configuration can be changed after manufacturing, such as a field-programmable gate array (FPGA), and a dedicated electric circuit that is a processor having a circuit configuration exclusively designed for executing specific processing, such as an application specific integrated circuit (ASIC). In addition, the traffic congestion determination processing may be performed by one of these various processors, or may be performed by a combination of two or more processors of the same type or different types (for example, a plurality of FPGAs, a combination of a CPU and an FPGA, and the like). Furthermore, a hardware structure of the various processors is, more specifically, an electric circuit in which circuit elements such as semiconductor elements are combined.

In the above embodiment, the aspect in which the traffic congestion determination program is stored (installed) in advance in the storage has been described, but the embodiment is not limited thereto. The program may be provided by being stored in a non-transitory storage medium such as a compact disk read only memory (CD-ROM), a digital versatile disk read only memory (DVD-ROM), and a universal serial bus (USB) memory. The program may be downloaded from an external device via a network.

Regarding the above embodiment, the following supplementary notes are further disclosed.

### (Supplement 1)

A traffic congestion determination device including:
a memory; and
at least one processor connected to the memory,
in which the processor is configured to
acquire a total number of automobiles for each mesh obtained by virtually dividing a determination target region of traffic congestion and for each unit time, and
determine whether occurrence of traffic congestion is sudden for each of the meshes based on the acquired total number of automobiles for each of the meshes and unit time.

### (Supplement 2)

A non-transitory storage medium storing a program that can be executed by a computer to execute traffic congestion determination processing including:
acquiring a total number of automobiles for each mesh obtained by virtually dividing a determination target region of traffic congestion and for each unit time; and
determining whether occurrence of traffic congestion is sudden for each of the meshes based on the acquired total number of automobiles for each of the meshes and unit time.

### REFERENCE SIGNS LIST

10 Traffic congestion determination device
21 Acquisition unit
22 Determination unit
23 Notification unit
30 Server
31, 31A Log database
32 Trajectory information database

1. A computer implemented method for determining traffic congestion, comprising:
acquiring, by a processor a total number of automobiles associated with each mesh of a plurality of meshes for each unit time, wherein each mesh is based on dividing a determination target region of traffic congestion into a number of the plurality of meshes at each unit time; and
determining, by the processor, whether occurrence of traffic congestion is incidental for each mesh of the plurality of meshes based on the acquired total number of automobiles for each mesh of the plurality of meshes and unit time.

2. The computer implemented method according to claim 1,
wherein the determining further comprises calculating an aggregation sudden index based on a total number of automobiles per mesh and per unit time, and the determining further comprises determining whether the occurrence of the traffic congestion is incidental based on the calculated aggregation sudden index.

3. The computer implemented method according to claim 1,
wherein the acquiring further comprises trajectory information of an automobile, and
the determining further comprises:
calculating a traffic congestion habit degree, the traffic congestion habit degree is based on a congestion occurrence probability, and the congestion occurrence probability is calculated based on the total number of automobiles for each mesh of the plurality of meshes and the unit time,
calculating a trajectory habit degree based on a passage probability based on the trajectory information,
calculating a weighted traffic congestion habit degree based on the traffic congestion habit degree, the trajectory habit degree, and a weight of the trajectory habit degree, and
determining whether the occurrence of the traffic congestion is incidental or chronic based on the calculated weighted traffic congestion habit degree.

4. The computer implemented method according to claim 3,
wherein the determining further comprises increasing the weight of the trajectory habit degree as a number of meshes for which the traffic congestion habit degree is not calculated increases.

5. The computer implemented method according to claim 3, further comprising:
notifying only a user satisfying a predetermined criterion of occurrence of the traffic congestion.

6. The computer implemented method according to claim 5,
wherein the user satisfying the predetermined criterion represents a user whose living area does not include a predetermined area, the predetermined area including a mesh in which the traffic congestion occurs chronically.

7. A traffic congestion determination device comprising a processor configured to execute operations comprising:
acquiring a total number of automobiles associated with each mesh of a plurality of meshes for each unit time, wherein each mesh is based on dividing a determination target region of traffic congestion into a number of the plurality of meshes at each unit time; and
determining whether occurrence of traffic congestion is incidental for each mesh of the plurality of meshes based on the acquired total number of automobiles for each mesh of the plurality of meshes and unit time.

8. A computer-readable non-transitory recording medium storing computer-executable program that when executed by a processor cause a computer system to execute operations comprising:
acquiring a total number of automobiles associated with each mesh of a plurality of meshes for each unit time, wherein each mesh is based on dividing a determination target region of traffic congestion into a number of the plurality of meshes at each unit time; and
determining whether occurrence of traffic congestion is incidental for each nesh of the plurality of meshes based on the acquired total number of automobiles for each mesh of the plurality of meshes and unit time.

9. The computer implemented method according to claim 1, the acquiring further comprises:
retrieving the total number of automobiles associated with each mesh from a database, wherein the database is index at least based on time and an identifier representing a mesh of the plurality of meshes.

10. The traffic congestion determination device according to claim 7, wherein the determining further comprises calculating an aggregation sudden index based on a total number of automobiles per mesh and per unit time, and the determining further comprises determining whether the occurrence of the traffic congestion is incidental based on the calculated aggregation sudden index.

11. The traffic congestion determination device according to claim 7,
wherein the acquiring further comprises acquiring trajectory information of an automobile, and
the determining further comprises:
calculating a traffic congestion habit degree, the traffic congestion habit degree is based on a congestion occurrence probability, and the congestion occurrence probability is calculated based on the total number of automobiles for each mesh of the plurality of meshes and the unit time,
calculating a trajectory habit degree based on a passage probability based on the trajectory information,
calculating a weighted traffic congestion habit degree based on the traffic congestion habit degree, the trajectory habit degree, and a weight of the trajectory habit degree, and
determining whether the occurrence of the traffic congestion is incidental or chronic based on the calculated weighted traffic congestion habit degree.

12. The traffic congestion determination device according to claim 7, wherein the acquiring further comprises:
retrieving the total number of automobiles associated with each mesh from a database, wherein the database is index at least based on time and an identifier representing a mesh of the plurality of meshes.

13. The traffic congestion determination device according to claim 11,
wherein the determining further comprises increasing the weight of the trajectory habit degree as a number of meshes for which the traffic congestion habit degree is not calculated increases.

14. The traffic congestion determination device according to claim 11, the processor further configured to execute operations comprising:
notifying only a user satisfying a predetermined criterion of occurrence of the traffic congestion.

15. The traffic congestion determination device according to claim 14, wherein the user satisfying the predetermined criterion represents a user whose living area does not include a predetermined area, the predetermined area including a mesh in which the traffic congestion occurs chronically.

16. The computer-readable non-transitory recording medium according to claim 8, wherein the determining further comprises calculating an aggregation sudden index based on a total number of automobiles per mesh and per unit time, and the determining further comprises determining whether the occurrence of the traffic congestion is incidental based on the calculated aggregation sudden index.

17. The computer-readable non-transitory recording medium according to claim 8, wherein the acquiring further comprises acquiring trajectory information of an automobile, and
the determining further comprises:
calculating a traffic congestion habit degree, the traffic congestion habit degree is based on a congestion occurrence probability, and the congestion occurrence probability is calculated based on the total number of automobiles for each mesh of the plurality of meshes and the unit time,
calculating a trajectory habit degree based on a passage probability based on the trajectory information,
calculating a weighted traffic congestion habit degree based on the traffic congestion habit degree, the trajectory habit degree, and a weight of the trajectory habit degree, and
determining whether the occurrence of the traffic congestion is incidental or chronic based on the calculated weighted traffic congestion habit degree.

18. The computer-readable non-transitory recording medium according to claim 8, wherein the acquiring further comprises:
retrieving the total number of automobiles associated with each mesh from a database, wherein the database is index at least based on time and an identifier representing a mesh of the plurality of meshes.

19. The computer-readable non-transitory recording medium according to claim 17,
wherein the determining further comprises increasing the weight of the trajectory habit degree as a number of meshes for which the traffic congestion habit degree is not calculated increases, and
the processor further configured to execute operations comprising:
notifying only a user satisfying a predetermined criterion of occurrence of the traffic congestion.

20. The computer-readable non-transitory recording medium according to claim 17, wherein the user satisfying the predetermined criterion represents a user whose living area does not include a predetermined area, the predetermined area including a mesh in which the traffic congestion occurs chronically.
